(19) United States
(12) Patent Application Publication
(10) Pub. No.: US 2010/0253276 A1
(43) Pub. Date: Oct. 7, 2010

(54) Power supply system and circuit control method thereof

(75) Inventors: Kuo-Tai Hung, Hsin-Chu (TW); Ken-Chih Chang, Hsin-Chu (TW)

Correspondence Address: BACON & THOMAS, PLLC, 625 SLATERS LANE, FOURTH FLOOR, ALEXANDRIA, VA, 22314-1176, US

(73) Assignee: Young Green Energy Co., Hsinchu County (TW)

(21) Appl. No.: 12/662,178

(22) Filed: Apr. 5, 2010

(30) Foreign Application Priority Data
Apr. 6, 2009 (TW) 098111379

(51) Int. Cl. H01M 10/46; H02J 3/32

(52) U.S. Cl. 320/101; 307/48

(57) ABSTRACT

A power supply system is adapted to providing a rated power to a load, and includes a fuel cell, a secondary battery, a charging device, and a control unit. The fuel cell provides a first power. The secondary battery provides a second power and is electrically connected with the fuel cell. The charging device is electrically connected with the fuel cell and the secondary battery.

The control unit is electrically connected with the fuel cell, the secondary battery, and the charging device. When the first power is smaller than the rated power, the control unit enables the secondary battery to provide power to the load. When the secondary battery supplies power to the load, the control unit enables the charging device so that the secondary battery is charged by the fuel cell via the charging device.

### BACKGROUND OF THE INVENTION

(1) Field of the Invention

The present invention relates to a power supply system, and more particularly, relates to an improved power supply system of a fuel cell and circuit control method thereof.

(2) Description of the Prior Art

Energy is exploited and used for higher quality of life. Fuel cell generates energy with high efficiency, low noise, and no pollution, which is in line with trend of the energy technology.

However, the fuel cell is a kind of energy device with slow starting. The fuel cell needs a period of time for startup before supplying power to a load. To output a certain level of power, the concentration and temperature of the fuel cell must reach a certain degree. In addition, a conventional fuel cell is not capable of providing large power in an instant. Therefore, if instant large power is needed, an additional secondary battery must be added as an auxiliary power supply. Moreover, the power capacity of the secondary battery is monitored, because operation life of the fuel cell will be influenced while the secondary battery is out of power.

Refer to FIG. 1 for a block diagram of a conventional power supply system 100. The power supply system 100 is capable of providing a rated power to a load 10, and includes a fuel cell 111, an internal secondary battery 112, an external load power supply circuit 113, an internal load power supply circuit 114, a selecting unit 115, a micro-processing unit 116, a charging unit 117, and an internal load 118.

The external load power supply circuit 113 is capable of converting the power from the fuel cell 111 into a specified voltage and outputs the specified voltage to the external load 10. The internal load power supply circuit 114 is capable of converting the power from the fuel cell 111 or the power from the internal secondary battery 112 into a specified voltage and outputs the specified voltage to the micro-processing unit 116, the charging unit 117 or the internal load 118.

The micro-processing unit 116 is adapted to control the charging unit 117 to determine whether providing the power from the fuel cell 111 to the internal secondary battery 112. When the internal secondary battery 112 supplies power to the micro-processing unit 116 or the internal load 118, the charging unit 117 stops running. In addition, the power supply system 100 may be connected in parallel with an external secondary battery 20 to provide power for the load 10 when the fuel cell 111 is inadequate to provide sufficient power.

However, in the startup of the conventional power supply system 100, the fuel cell 111 can not provide power to the external load 10, so that the power supply system 100 itself is unable to provide power and the external secondary battery 20 is needed as the initial power supply. The conventional power supply system 100 does not capable of providing large power to the load 10 in an instant, and it needs the external secondary battery 20 to do that.

Moreover, the internal secondary battery 112 and the external secondary battery 20 both output specified voltage, and the voltage of the internal secondary battery 112 and the voltage of the external secondary battery 20 both need to match the required voltage of the load 10. For example, if the internal secondary battery 112 and the external secondary battery 20 are both lithium batteries and the voltage of the lithium battery is a multiple of 3.7V, the voltage of the internal secondary battery 112 and the voltage of the external secondary battery 20 will destroy the load 10 or is unable to drive the load 10. Thus, the power supply system 100 is restricted by the specified output voltage from the internal secondary battery 112 and the external secondary battery 20.

Thus, it is an urgent problem in the art that the conventional power supply system 100 can not provide power immediately or instant high power as well as is restricted by the specified voltage of the internal secondary battery 112 and the external secondary battery 20.

### SUMMARY OF THE INVENTION

One object of the present invention to provide a power supply system capable of supplying power immediately, and providing an instant large power.

To achieve one of, a part of or all of the above-mentioned advantages, an embodiment of the present invention provides a power supply system capable of providing a rated power to a load. The power supply system includes a fuel cell, a secondary battery, a charging device, and a control unit. The fuel cell provides a first power. The secondary battery provides a second power and electrically connected to the fuel cell. The charging device is electrically connected to the fuel cell and the secondary battery. The control unit is electrically connected to the fuel cell, the secondary battery, and the charging device. The control unit enables the secondary battery to provide power to the load when the first power is smaller than the rated power, and the control unit enables the charging device so that the fuel cell charges the secondary battery via the charging device during the secondary battery providing power to the load.

In an embodiment, when the first power is larger than the rated power, the control unit enables the fuel cell to provide power to the load, and the control unit enables the charging device during the fuel cell providing power to the load. The control unit enables the fuel cell to provide power to the load and disables the charging device when the first power is equal to the rated power. The control unit enables the fuel cell and the secondary battery to provide power to the load together if the load needs an instant power larger than the rated power.

In an embodiment, the power supply system further includes a first load power supply circuit and a second load power supply circuit, wherein the first load power supply circuit is electrically connected to the fuel cell and adapted to accept the first power to output a first specified voltage which is a stable output of the fuel cell, and the second load power supply circuit is electrically connected to the secondary battery and adapted to accept the second power to output a second specified voltage which is a stable output of the secondary battery.

In an embodiment, the second load power supply circuit is a transformer, and the second load power supply circuit is adapted to adjust the second specified voltage to reach a rated voltage of the load. In another embodiment, the second load power supply circuit is a switch when the second specified voltage is equal to a rated voltage of the load.

In an embodiment, the power supply system further includes a selecting circuit electrically connected to the first load power supply circuit and the second power supply circuit. The selecting circuit includes a diode, a transistor, and a controller. The diode is electrically connected to the first load power supply circuit and adapted to switch the output of the first specified voltage. The transistor is electrically connected to the second load power supply circuit and adapted to switch the output of the second specified voltage. The controller is electrically connected to the first load power supply circuit, the second load power supply circuit and the transistor, and adapted to control the transistor by comparing the first specified voltage with the second specified voltage.

In an embodiment, the power supply system further includes a first detector electrically connected to the fuel cell and the control unit, and adapted to detect a value of the first power.

In an embodiment, the power supply system further includes a second detector electrically connected to the secondary battery and the control unit and adapted to detecting a value of the second power.

To achieve one of, a part of or all of the above-mentioned advantages, an embodiment of the present invention provides a circuit control method of the power supply system adapted to provide a rated power and a rated voltage to a load. The power supply system has a fuel cell, a secondary battery, a charging device and a control unit. The fuel cell provides a first power and then outputs a first specified voltage. The secondary battery provides a second power and outputs a second specified voltage. The charging device is electrically connected to the fuel cell and the secondary battery. The control unit is electrically connected to the fuel cell, the secondary battery, and the charging device. The circuit control method includes steps of: detecting the first power; determining whether the first power reaches the rated power or not; detecting the second specified voltage during the first power being smaller than the rated power; determining whether the second specified voltage reaches the rated voltage or not; and enabling the charging device by the control unit so as to charge the secondary battery via the charging device during the second specified voltage being smaller than the rated voltage.

In an embodiment, disabling the charging device by the control unit when the second specified voltage reaches the rated voltage.

In an embodiment, the power supply system further includes the first load power supply circuit and the second load power supply circuit. The first load power supply circuit is electrically connected to the fuel cell and adapted to accept the first power and output a first specified voltage for being a stable output of the fuel cell. The second load power supply circuit is electrically connected to the secondary battery and adapted to accept the second power and output a second specified voltage for being a stable output of the second battery.

The control unit disables the first load power supply circuit and enables the second load power supply circuit during the first power being smaller than the rated power. The control unit enables the first load power supply circuit and detects the first specified voltage and determines whether the first specified voltage reaches the rated voltage or not when the first power reaches the rated power. The control unit detects the second specified voltage when the first specified voltage reaches the rated voltage. The control unit disables the charging device during the first specified voltage being smaller than the rated voltage.

Compared with the prior art, the secondary battery in the embodiment of the present invention makes the power supply system capable of supplying power immediately for starting the power supply system quickly. And, the selecting circuit makes the fuel cell and the secondary battery output a instant large power for satisfying the demand of large current of the load. Besides, the second load power supply circuit can generate the rated voltage for the load by adjusting the second voltage, so that the power supply system is not restricted by the specified output voltage from the secondary battery and there are kinds of the secondary battery can be selected

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a block diagram of a conventional power supply system.

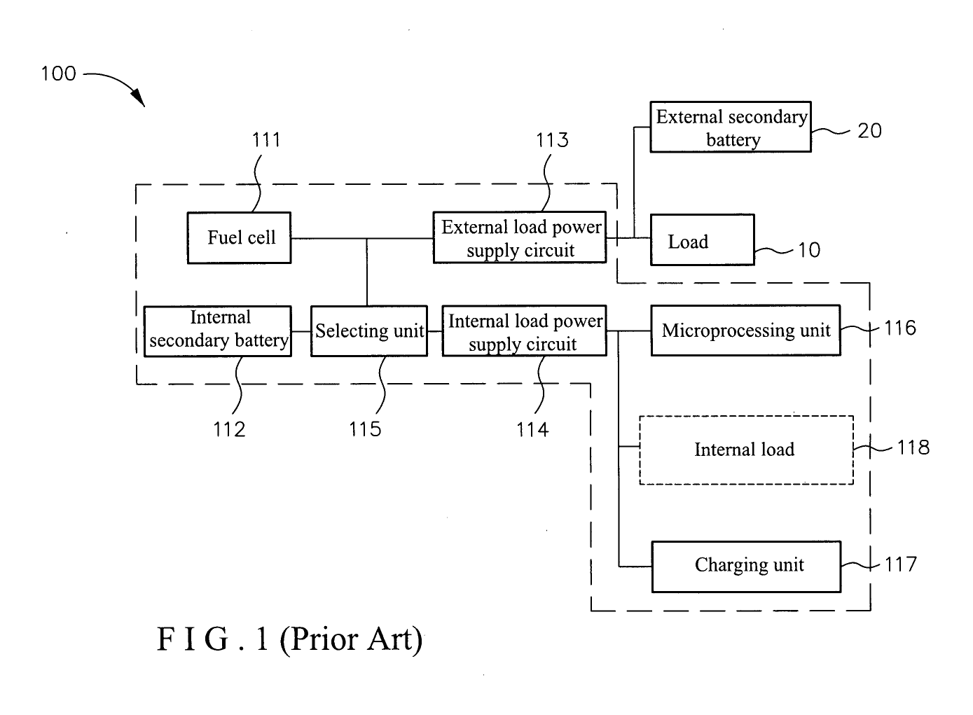

FIG. 2 is a block diagram of a power supply system according to an embodiment of the present invention.

FIG. 3 is a schematic view of a selecting circuit according to an embodiment of the present invention.

FIG. 4 is a flow chart of a circuit control method of the power supply system according to an embodiment of the present invention.

### DESCRIPTION OF THE PREFERRED EMBODIMENTS

It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and “coupled,” and variations thereof herein are used broadly and encompass direct and indirect connections, couplings, and mountings.

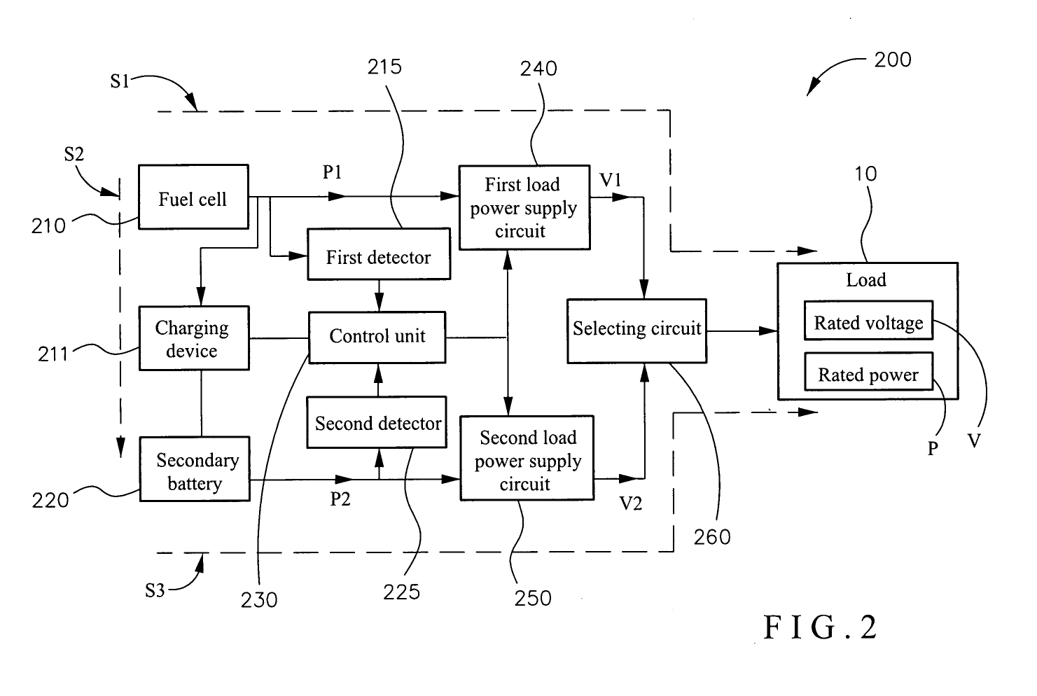

Refer to FIG. 2 for a block diagram of an embodiment of a power supply system 200 according to the present invention. The power supply system 200 is adapted to provide a rated power P and a rated voltage V to a load 10, and includes a fuel cell 210, a secondary battery 220, a charging device 211, and a control unit 230.

The fuel cell 210 provides a first power P1. The secondary battery 220 provides a second power P2. The charging device 211 is electrically connected with the fuel cell 210 and the secondary battery 220. The secondary battery 220 is charged by the fuel cell 210 via the charging device 211.

The present power supply system 200 further includes a first detector 215 and a second detector 225. The first detector 215 is electrically connected with the fuel cell 210 and the control unit 230 to detect a value of the first power P 1. The second detector 225 is electrically connected with the secondary battery 220 and the control unit 230 to detect a value of the second power P2.

The control unit 230 is electrically connected with the first detector 215 and the second detector 225 to determine values of the first power P1 of the fuel cell 210 and the second power P2 of the secondary battery 220 respectively.

The power supply system 200 further includes a first load power supply circuit 240 and a second load power supply circuit 250. The first load power supply circuit 240 is electrically connected with the fuel cell 210 to accept the first power P1 for outputting a first specified voltage V1. The first specified voltage V1 is a stable output of the fuel cell 210. The second load power supply circuit 250 is electrically connected with the secondary battery 220 to accept the second power P2 for outputting a second specified voltage V2. The second specified voltage V2 is a stable output of the secondary battery 220.

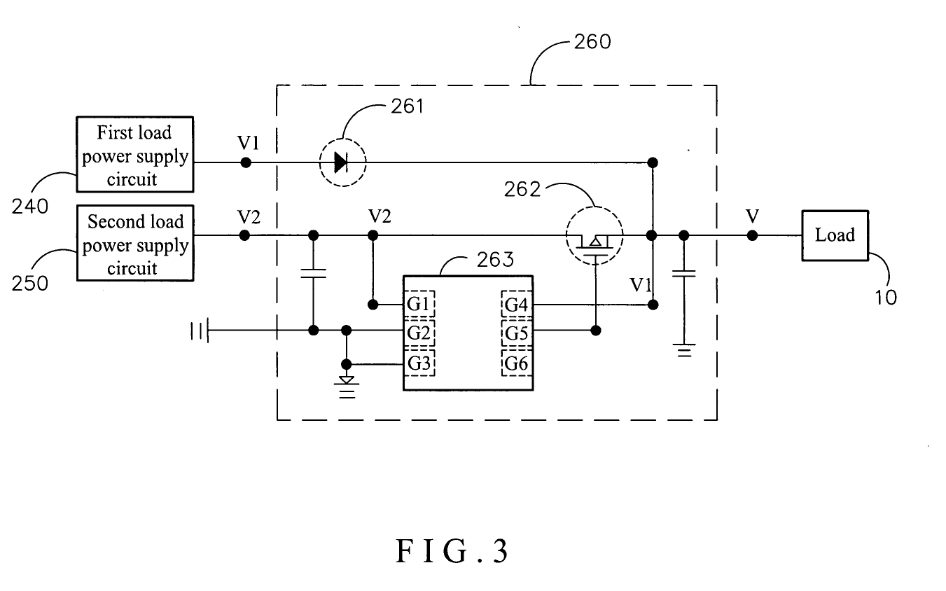

In an embodiment, the second load power supply circuit 250 is such as a transformer to reach the rated voltage V for the load 10 by adjusting the second voltage V2. In such a way, it solves the problem that the power supply system 200 is restricted by the specified output voltage from the secondary battery 220, so that there are kinds of the secondary batteries 220 can be selected. However, in another embodiment, when the second specified voltage V2 is equal to the rated voltage V of the load 10 or the second specified voltage V2 matches the load 10, the second load power supply circuit 250 functions as a switch to control the operation of the secondary battery 220. The power supply system 200 further includes a selecting circuit 260. The selecting circuit 260 is electrically connected to the first load power supply circuit 240 and the second load power supply circuit 250. Refer to FIG. 3 for a schematic view of the selecting circuit 260 according to an embodiment of the present invention. The selecting circuit 260 includes a diode 261, a transistor 262, and a controller 263.

The diode 261 is electrically connected to the first load power supply circuit 240 and adapted to control the first specified voltage V1. When the first specified voltage V1 is larger than the second specified voltage V2, the diode 261 is forward biased to turn on the first specified voltage V1 output. When the first specified voltage V1 is smaller than the second specified voltage V2, the diode 261 is reverse biased to turn off the first specified voltage V1 output.

The transistor 262 is electrically connected to the second load power supply circuit 250 and adapted to control the second specified output voltage V2. The controller 263, for example, has pins G1-G6. Pin G1 is electrically connected to the second load power supply circuit 250; pins G2 and G3 are grounded; pin G4 is electrically connected to the first load power supply circuit 240; and G5 is electrically connected to the transistor 262. The controller 263 accepts the second specified voltage V2 and the first specified voltage V1 via pins G1 and G4 respectively, and switches the transistor 262 via pin G5 by comparing the first specified voltage V1 with the second specified voltage V2. For example, the type of the controller 263 can be LTC4412.

If the first specified voltage V1 is larger than the second specified voltage V2, the transistor 262 is turned off to stop outputting the second specified voltage V2. The first specified voltage V1 is inputted to the load 10. At this time, if the load 10 needs an instant power larger than the rated power P, the first specified voltage V1 is decreased resulting from supplying power to the load 10. When the first specified voltage V1 is decreased to be equal to the second specified voltage V2, the transistor 262 is turned on to output of the second specified voltage V2. The first specified voltage V1 and the second specified V2 are inputted to the load 10 together for providing the instant large power for the load 10. When the first specified voltage V1 is smaller than the second specified voltage V2, the transistor 262 is turned on for supplying the second specified voltage V2 to the load 10.

Referring to FIG. 2, when the first power P1 is larger than the rated power P, as a dashed line Si shows, the control unit 230 enables the fuel cell 210 to provide power for the first load power supply circuit 240, and the first load power supply circuit 240 accepts the first power P1 and then outputs a first specified voltage V1. The selecting circuit 260 selects the first specified voltage V1 that is inputted to the load 10. At this time, the first specified voltage V1 is large enough for supplying the rated voltage of the load 10, and the first specified voltage V1 is larger than the second specified voltage V2. As a dashed line S2 shows, during the fuel cell 210 supplying the first specified voltage V1 to the load 10, the control unit 230 enables the charging device 211, so that the secondary battery 220 is charged by the fuel cell 210 via the charging device 211.

When the first power P1 is equal to the rated power P, the control unit 230 disables the charging device 211, so that the fuel cell 210 stops charging the secondary battery 220.

When the first power P1 is smaller than the rated power P, as a dashed line S3 shows, the control unit 230 enables the secondary battery 220 to supply power to the second load power supply circuit 250, and the second load power supply circuit 250 accepts the second power P2 and then outputs the second specified voltage V2. The selecting circuit 260 selects the second specified voltage V2 to input for the load 10. During the secondary battery 220 supplying the second specified voltage V2 to the load 10, as the dashed line S2 shows, the control unit 230 enables the charging device 211, so that the secondary battery 220 is charged by the fuel cell 210 via the charging device 211. When the load 10 needs an instant power that is larger than the rated power P, as the dashed lines S1 and S3 show, the control unit 230 enables the fuel cell 210 and the secondary battery 220 to supply power to the load 10 together.

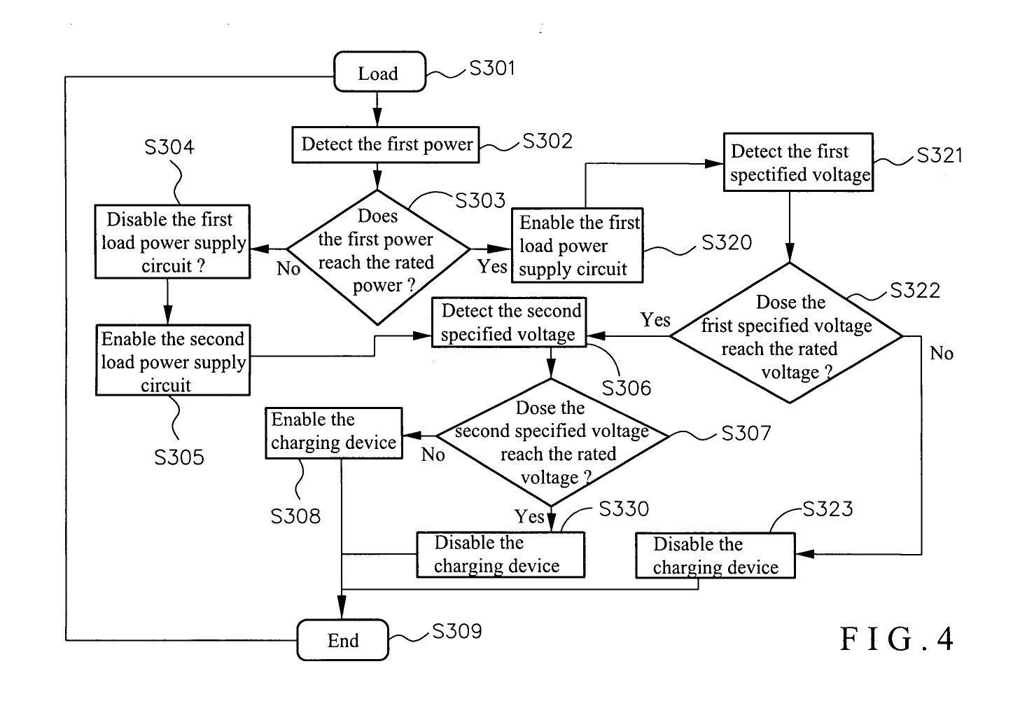

Please refer to FIG. 4, which is a flow chart of the circuit control method of the power supply system in accordance with an embodiment of the present invention. A circuit control method is adapted to the power supply is system 200 which is used to provide a rated power and a rated voltage for the load 10. The power supply system 200 has the fuel cell 210, the secondary battery 220, the charging device 211, and the control unit 230. The fuel cell 210 provides the first power and outputs the first specified voltage. The secondary battery 220 provides the second power and outputs the second specified voltage. The charging device 211 is electrically connected to the fuel cell 210 and the secondary battery 220. The control unit 230 is electrically connected to the fuel cell 210, the secondary battery 220 and the charging device 211.

The power supply system 200 further includes the first load power supply circuit 240 and the second load power supply circuit 250. The first load power supply circuit 240 is electrically connected to the fuel cell 210 and is adapted to accept the first power P1 and then output a first specified voltage V1. The first specified voltage V1 is a stable output of the fuel cell 210. The second load power supply circuit 250 is electrically connected to the secondary battery 220 and is adapted to accept the second power P2 and then output the second specified voltage V2. The second specified voltage V2 is a stable output of the secondary battery 220.

The steps of the circuit control method of the power supply system are described as follows.

Start the circuit control method of the power supply system (S301), and then the control unit 230 detects the first power P1 (S302) and determines whether the first power P1 reaches the rated power P (S303) or not.

If the control unit 230 determines that the first power P1 is smaller than the rated power P (S303), the control unit 230 disables the first load power supply circuit 240 (S304), so that the fuel cell 210 stops supplying the first power P1 to the first load power supply circuit 240 and enables the second load power supply circuit 250 (S305) so that the secondary battery 220 provides the second power P2 to the second load power supply circuit 250. The second load power supply circuit 250 accepts the second power P2 and then outputs a second specified voltage V2. The control unit 230 detects the second specified voltage V2 (S306) and determines whether the second specified voltage V2 reaches the rated voltage or not (S307).

If the control unit 230 determines that the first power P1 reaches the rated power P (S303), then the control unit 230 enables the first load power supply circuit 240 (S320) so that the fuel cell 230 provides the first power P1 to the first load power supply circuit 240, and the first load power supply circuit 240 outputs the first specified voltage V1. Subsequently, the control unit 230 detects the first specified voltage V1 (S321) for determining whether the first specified voltage V1 reaches the rated voltage V or not (S322).

If the first specified voltage V1 is equal to or smaller than the rated voltage V (S322), the control unit 230 disables the charging device 211 (S323) so that the fuel cell 210 stops charging the secondary battery 220 and the circuit control method of the power supply system 200 (S309) is terminated.

If the first specified voltage V1 is larger than the rated voltage V (S322), the control unit 230 detects the second specified voltage V2 (S306) and determines whether the second specified voltage V2 reaches the rated voltage V or not (S307). If the second specified voltage V2 is smaller than the rated voltage V, the control unit 230 enables the charging device (S308) so that the secondary battery 220 is charged by the fuel cell 210 via the charging device 211. If the second specified voltage V2 reaches the rated voltage V, the control unit 230 disables the charging device (S330) so that the fuel cell 210 stops charging the secondary battery 220, and the circuit control method of the power supply 100 (S309) is terminated.

To sum up, the above embodiments have at least one of following advantages.

1. With the secondary battery 220, the power supply system 200 is capable of supplying power immediately for actuating the power supply system 200 quickly.

2. With the selecting circuit 260, the fuel cell 210 and the secondary battery 220 can supply an instant large power for satisfying the demand of instant large power of the load 10.

3. The second load power supply circuit 250 can supply the rated voltage V for the load 10 by adjusting the second specified voltage V2, so that the power supply system 200 is not restricted by the specified output voltage from the secondary battery 220 and there are kinds of the secondary batteries 220 can be selected.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specified embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A power supply system, adapted to provide a rated power to a load, the power supply system comprising:
a fuel cell, capable of providing a first power;
a secondary battery, capable of providing a second power and electrically connected to the fuel cell;
a charging device, electrically connected to the fuel cell and the secondary battery; and
a control unit, electrically connected to the fuel cell, the secondary battery, and the charging device,
wherein the control unit enables the secondary battery to provide power to the load when the first power is smaller than the rated power, and the control unit enables the charging device so that the fuel cell charges the secondary battery via the charging device during the secondary battery providing power to the load.

2. The power supply system of claim 1, wherein the control unit enables the fuel cell to provide power to the load when the first power is larger than the rated power, and the control unit enables the charging device during the fuel cell providing power to the load.

3. The power supply system of claim 1, wherein the control unit enables the fuel cell to provide power to the load and disables the charging device when the first power is equal to the rated power.

4. The power supply system of claim 1, wherein the control unit enables the fuel cell and the secondary battery to provide power to the load together if the load needs an instant power larger than the rated power.

5. The power supply system of claim 1, further comprising a first load power supply circuit and a second load power supply circuit, wherein the first load power supply circuit is electrically connected to the fuel cell and adapted to accept the first power to output a first specified voltage being a stable output of the fuel cell, and the second load power supply circuit is electrically connected to the secondary battery and adapted to accept the second power to output a second specified voltage being a stable output of the secondary battery.

6. The power supply system of claim 5, further comprising a selecting circuit electrically connected to the first load power supply circuit and the second power supply circuit, the selecting circuit comprising:
a diode, electrically connected to the first load power supply circuit and adapted to switch the output of the first specified voltage;
a transistor, electrically connected to the second load power supply circuit and adapted to switch the output of the second specified voltage; and
a controller, electrically connected to the first load power supply circuit, the second load power supply circuit, and the transistor, and adapted to control the transistor by comparing the first specified voltage with the second specified voltage.

7. The power supply system of claim 5, wherein the second load power supply circuit is a transformer, and the second load power supply circuit is adapted to adjust the second specified voltage to reach a rated voltage of the load.

8. The power supply system of claim 5, wherein the second load power supply circuit is a switch when the second specified voltage is equal to a rated voltage of the load.

9. The power supply system of claim 1, further comprising a first detector electrically connected to the fuel cell and the control unit, and adapted to detect a value of the first power.

10. The power supply system of claim 1, further comprising a second detector, electrically connected to the secondary battery and the control unit and adapted to detect a value of the second power.

11. A circuit control method of the power supply system, adapted to provide a rated power and a rated voltage to a load, the power supply system comprising a fuel cell, a secondary battery, a charging device, and a control unit, the fuel cell capable of providing a first power and outputting a first specified voltage, the secondary battery capable of providing a second power and outputting a second specified voltage, the charging device electrically connected to the fuel cell and the secondary battery, the control unit electrically connected to the fuel cell, the secondary battery, and the charging device, the circuit control method comprising steps of:
detecting the first power;
determining whether the first power reaches the rated power or not;
detecting the second specified voltage during the first power being smaller than the rated power;
determining whether the second specified voltage reaches the rated voltage or not; and
enabling the charging device by the control unit, so as to charge the secondary battery via the charging device during the second specified voltage being smaller than the rated voltage.

12. The circuit control method of claim 11, further comprising disabling the charging device by the control unit when the second specified voltage reaches the rated voltage.

13. The circuit control method of claim 11, wherein the power supply system further comprising a first load power supply circuit and a second load power supply circuit, the first load power supply circuit electrically connected to the fuel cell and adapted to accept the first power and output a first specified voltage for being a stable output of the fuel cell, the second load power supply circuit electrically connected to the secondary battery and adapted to accept the second power and output a second specified voltage for being a stable output of the second battery.

14. The circuit control method of claim 13, further comprising disabling the first load power supply circuit by the control unit and enabling the second load power supply circuit during the first power being smaller than the rated power.

15. The circuit control method of claim 13, further comprising enabling the first load power supply circuit by the control unit and detecting the first specified voltage and determining whether the first specified voltage reaches the rated voltage or not when the first power reaches the rated power.

16. The circuit control method of claim 15, further comprising detecting the second specified voltage by the control unit when the first specified voltage reaches the rated voltage.

17. The circuit control method of claim 15, further comprising disabling the charging device by the control unit during the first specified voltage being smaller than the rated voltage.
